(19) United States
(12) Patent Application Publication
(10) Pub. No.: US 2017/0326479 A1
(43) Pub. Date: Nov. 16, 2017

(54) WATER FILTER

(71) Applicant: Glacier Fresh, Paterson, NJ (US)

(72) Inventors: Qiang Lu, Ningbo City (CN); Xijin Wu, Dongyang City (CN); Fevzi Arif, Paterson, NJ (US)

(21) Appl. No.: 15/151,352

(22) Filed: May 10, 2016

(51) Int. Cl. B01D 29/58; F25D 23/00; C02F 1/28; B01D 29/15; C02F 101/10; C02F 101/14; C02F 101/30

(52) U.S. Cl. CPC B01D 29/58; B01D 29/15; F25D 23/00; C02F 1/281; C02F 1/283; B01D 2201/291; B01D 2201/04; C02F 2101/14; C02F 2101/30; C02F 2201/003; C02F 2307/12; C02F 2101/103

(57) ABSTRACT

A replaceable water filter includes a filter assembly having a filter structure with first, second, and third filtering elements sharing a common axis, the first filtering element for removing and/or reducing particulate contaminants in the water, the second filtering element for removing and/or reducing particulate and organic contaminants in the water and the third filtering element for removing and/or reducing at least one of fluoride and arsenic in the water. The filter further includes a housing that contains the filter assembly. The housing includes a first end adapted to removably attach the filter to a filter mount of the refrigerator where the filter communicates with the water supply of the refrigerator. The first filtering element can be fabric, the second filtering element can be a carbon block, and the third filtering element can be activated alumina.

### FIELD

The present disclosure relates to water filtration. More particularly, the present disclosure relates to a replaceable water filter for a refrigerator.

### BACKGROUND

Household water filtration devices are now quite common due to the benefits derived from drinking highly pure water. In addition, many of the household refrigerators sold today include refrigerator mounted water dispensers and automatic ice makers.

In response to these facts, the household refrigerators with refrigerator mounted water dispensers and automatic ice makers typically incorporate replaceable water filters, which filter the water supply dispensed by the refrigerator water dispenser and/or used by the refrigerator automatic ice maker in making ice cubes.

Unfortunately, the replaceable water filters sold today for use in refrigerators, do not adequately remove and/or reduce fluoride and/or arsenic in the water. Excessive fluorides in drinking water can cause collagen breakdown in the body, permanently discolor the teeth, cause osteoporosis, or cause skeleton fluorosis. Arsenic can cause nausea, vomiting, neurological and/or cardiovascular effects, decreased production of red and white blood cells skin thickening and color changes, and increased risk of skin, bladder, kidney, prostate, and lung cancer.

Accordingly, a replaceable water filter is needed, which is capable of removing and/or reducing unhealthy levels of fluoride and arsenic in the water supply dispensed by water dispenser and/or used by the automatic ice maker of a refrigerator.

### SUMMARY

Disclosed herein is a replaceable filter for filtering a water supply of a refrigerator. In some embodiments, the filter may comprise a filter assembly comprising a first filtering element for removing and/or reducing at least one of fluoride and arsenic in the water and a housing containing the filter assembly, the housing including a first end adapted to removably attach the filter to a filter mount of the refrigerator where the filter communicates with the water supply of the refrigerator. In some embodiments, the first filtering element may comprise activated alumina. In some embodiments, the filter assembly may further comprise a second filtering element for removing and/or reducing particulate matter in the water. In some embodiments, the second filtering element may comprise a fabric. In some embodiments, the filter assembly may further comprise a second filtering for removing and/or reducing particulate and organic contaminants in the water. In some embodiments, the second filtering element may comprise a carbon block. In some embodiments, the filter assembly may further comprise second and third filtering elements, one of the second and third filtering elements for removing and/or reducing particulate matter in the water and the other one of the second and third filtering elements for removing and/or reducing particulate and organic contaminants in the water. In some embodiments, one of the second and third filtering elements may comprise fabric and the other one of the second and third filtering elements may comprise a carbon block. In some embodiments, the second filtering element may comprise a carbon block.

In further embodiments, the replaceable filter may comprise a filter assembly comprising first and second filtering elements, the first filtering element for removing and/or reducing particulate and organic contaminants in the water and the second filtering element for removing and/or reducing at least one of fluoride and arsenic in the water and a housing containing the filter assembly, the housing including a first end adapted to removably attach the filter to a filter mount of the refrigerator where the filter communicates with the water supply of the refrigerator. In some embodiments, the first filtering element may comprise a carbon block. In some embodiments, the second filtering element may comprise activated alumina. In some embodiments, the filter assembly may include a tubular core member which contains the second filtering element. In some embodiments, the first filtering element may be disposed about the tubular core member. In some embodiments, the filter assembly may further comprise a filter cap including a tubular member extending into an inlet end of the tubular core member, the tubular member being tapered to provide a space between the inlet end of the tubular core member and the tubular member, thereby allowing water filtered by the first filtering element to enter the tubular core member and be filtered by the second filtering element. In some embodiments, the filter assembly may further comprise a third filtering element for removing and/or reducing particulate matter in the water. In some embodiments, the third filtering element may comprise fabric.

In still other embodiments, the replaceable filter may comprise a filter assembly comprising a filter structure having first, second, and third filtering elements sharing a common axis, the first filtering element for removing and/or reducing particulate contaminants in the water, the second filtering element for removing and/or reducing particulate and organic contaminants in the water and the third filtering element for removing and/or reducing at least one of fluoride and arsenic in the water and a housing containing the filter assembly, the housing including a first end adapted to removably attach the filter to a filter mount of the refrigerator where the filter communicates with the water supply of the refrigerator. In some embodiments, the first filtering element may comprise fabric, the second filtering element may comprise a carbon block, and the third filtering element may comprise activated alumina. In some embodiments, the first filtering element may be wrapped about the second filtering element. In some embodiments the second filtering element may include a bore and the filter assembly may further comprises a tubular core member disposed in the bore, the tubular core member containing the third filtering element. In some embodiments the filter assembly may further comprise a filter cap including a tubular member extending into an inlet end of the tubular core member, the tubular member being tapered to provide a space between the inlet end of the tubular core member and the tubular member, thereby allowing water filtered by the first and second filtering elements to enter the tubular core member and be filtered by the third filtering element. In some embodiments, the filter cap may comprise a first filter cap and the filter assembly may further comprise a second filter cap, the filter structure being retained between the first and second filter caps, the second filter cap may comprise a tubular member extending into an outlet end of the tubular core member and operative as a water outlet.

### BRIEF DESCRIPTION OF THE DRAWINGS

These and further features of the present disclosure will be described hereafter with reference to the following description and drawings in which like-reference numerals represent like-parts throughout the description and drawings.

FIG. 1A is a front view of a household refrigerator incorporating a replaceable water filter according to an embodiment of the present disclosure.

FIG. 1B is a perspective view of an embodiment of the water filter of the present disclosure removably attached to a filter mount, which fluidly connects the water filter into a water supply system of the refrigerator.

FIG. 2 is a perspective view of an embodiment of the replaceable water filter of the present disclosure.

FIG. 3A is an elevational view of the water filter shown in FIG. 2

FIG. 3B is a top plan view of the water filter illustrated in FIG. 2.

FIG. 3C is a bottom plan view of the water filter shown in FIG. 2.

FIG. 4 is a bottom plan view of an upper cover of the water filter shown in FIG. 2.

FIG. 5 is an exploded view of the water filter shown in FIG. 2.

FIG. 6 is a cross-sectional view through line 3B-3B of the replaceable water filter illustrated in FIG. 2.

FIG. 7 is a perspective view of replaceable water filter illustrated in FIG. 2, with a portion of the housing cutaway to illustrate water flow through the filter.

### DETAILED DESCRIPTION

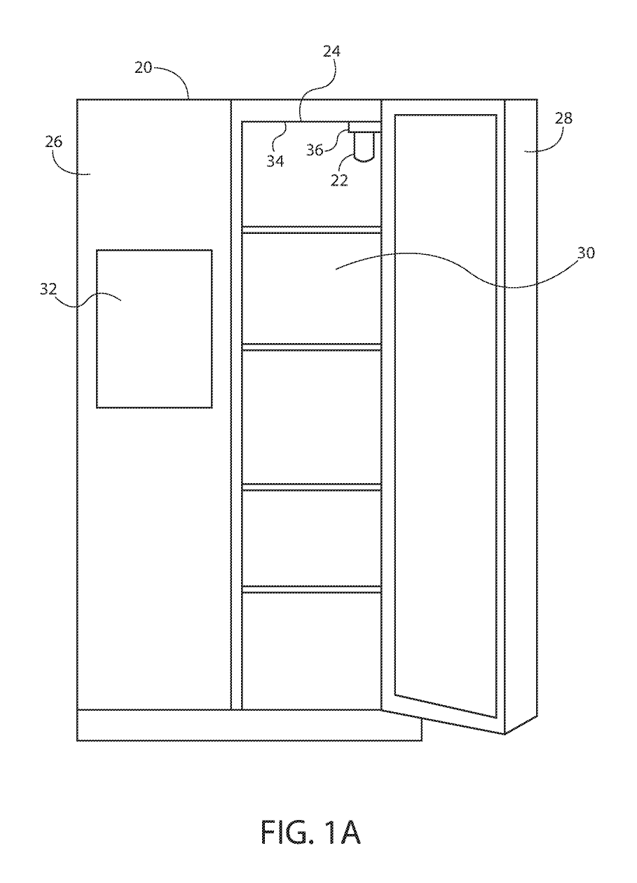

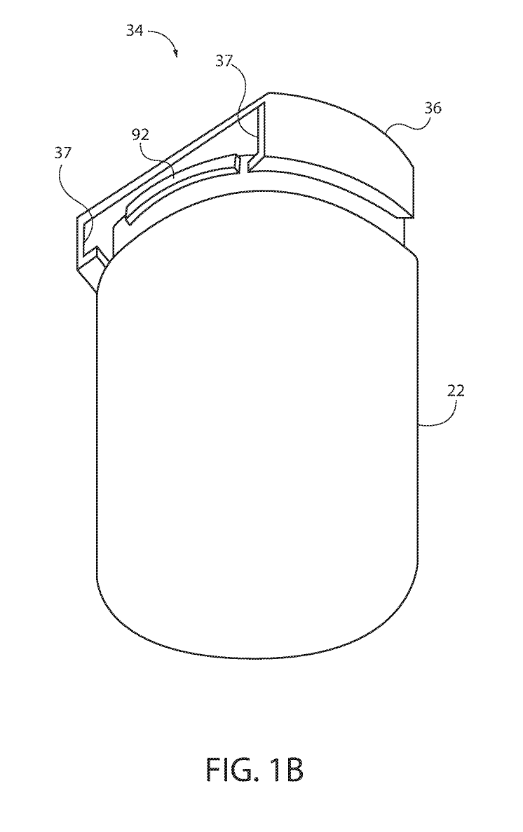

FIG. 1A illustrates a household refrigerator 20 including a replaceable water filter 22 according to the present disclosure. The refrigerator includes a cabinet 24 having a plurality of insulated walls. A freezer door 26 and a refrigerator door 28 may be pivotally mounted to the cabinet 24 and when closed, from a freezer compartment (not shown) and a refrigeration compartment 30. The refrigerator further includes an ice maker 32 and a freezer-door mounted ice and water dispenser 34.

The refrigerator 20 illustrated in FIG. 1A is commonly known in the art as a “side-by-side” refrigerator. One or ordinary skill in the art will recognize that the water filter 22 of the present disclosure can be used in other types of household refrigerators, including without limitation, refrigerators having freezer and refrigeration compartments, which are vertically offset relative to one another. The water filter 22 of the present disclosure can also be used in household refrigerators that do not include an automatic ice maker, and in refrigerators wherein the ice and/or water dispenser is not accessible from an exterior of the refrigerator.

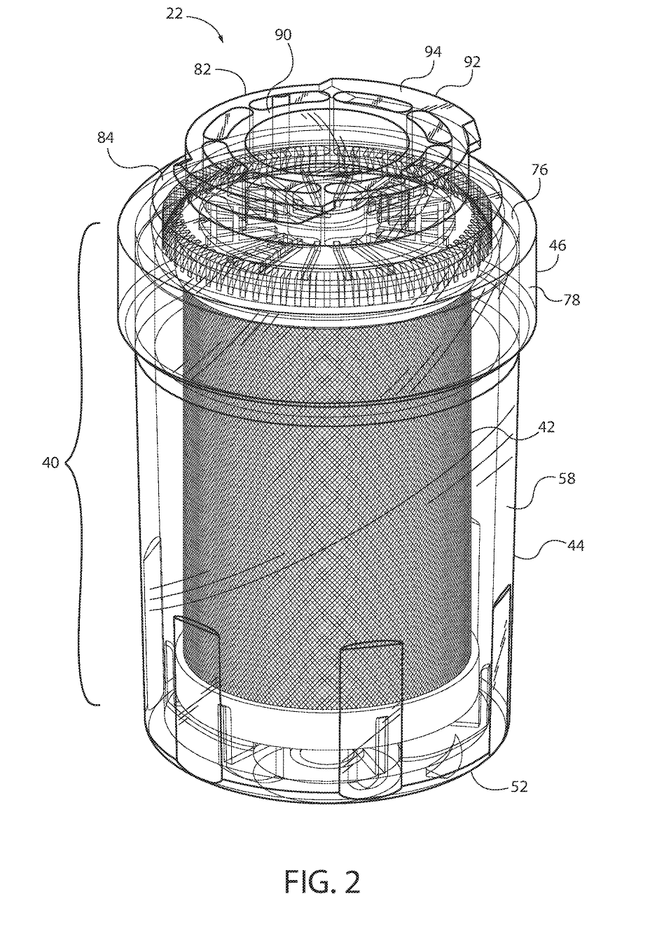

Referring now to FIG. 2, the water filter 22 comprises a filter housing 40 and a filter assembly 42 disposed within the filter housing 40. The filter housing 40 includes a shell 44 and an upper end cover 46 bonded and/or mechanically fastened to the shell 44 using any conventional bonding and/or mechanical fastening method. The upper end cover 46 of the filter housing 40 is adapted to allow the water filter 22 to be removably attached to a filter mount 36, as illustrated in FIGS. 1A and 1B, which fluidly connects the water filter 22 into a water supply system (not shown) of the refrigerator 20. The filter mount 36 can be provided on a top wall 34 of the cabinet 24 in an upper corner 38 of the refrigeration compartment 30, as illustrated in FIG. 1A. The filter housing 40 can be made from a transparent material so that the filter assembly 42 can be viewed through the housing 40 during the operation of the water filter 22, which allows the user to observe the operation thereof.

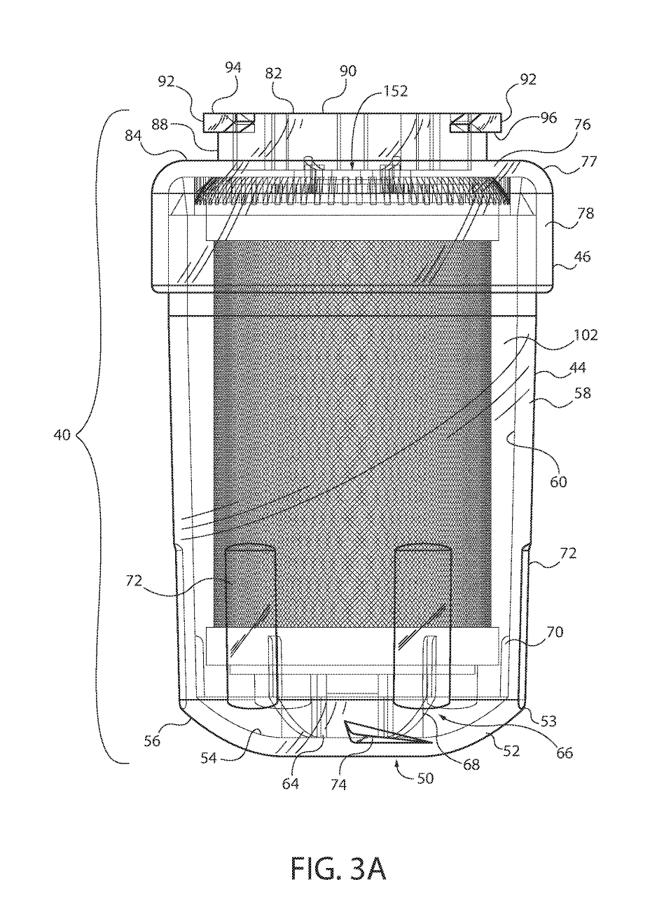

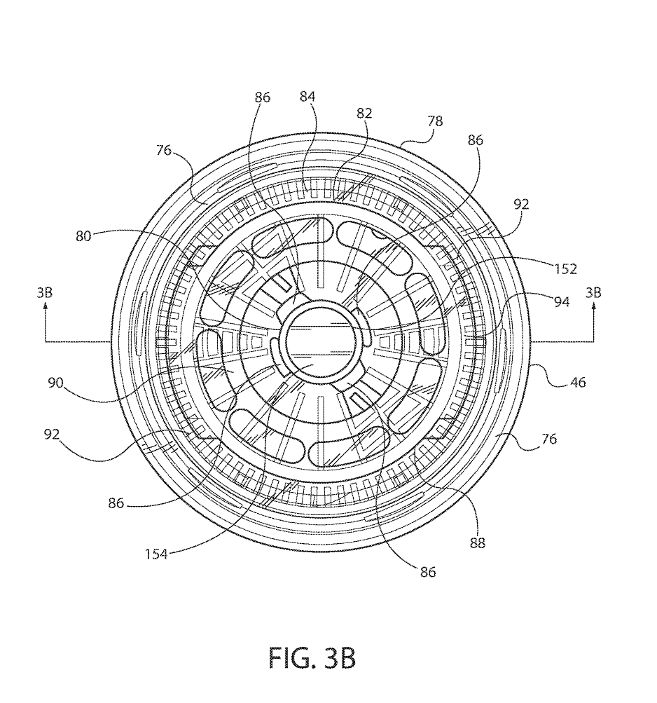

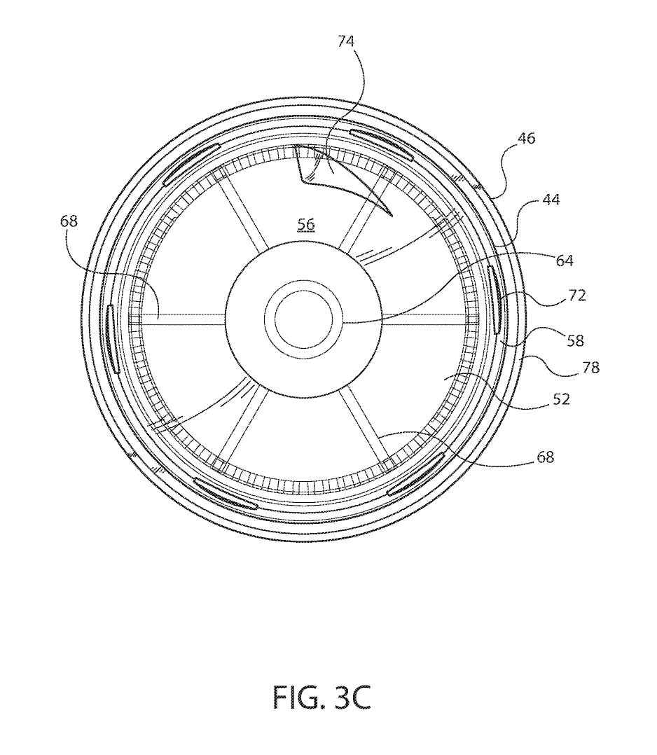

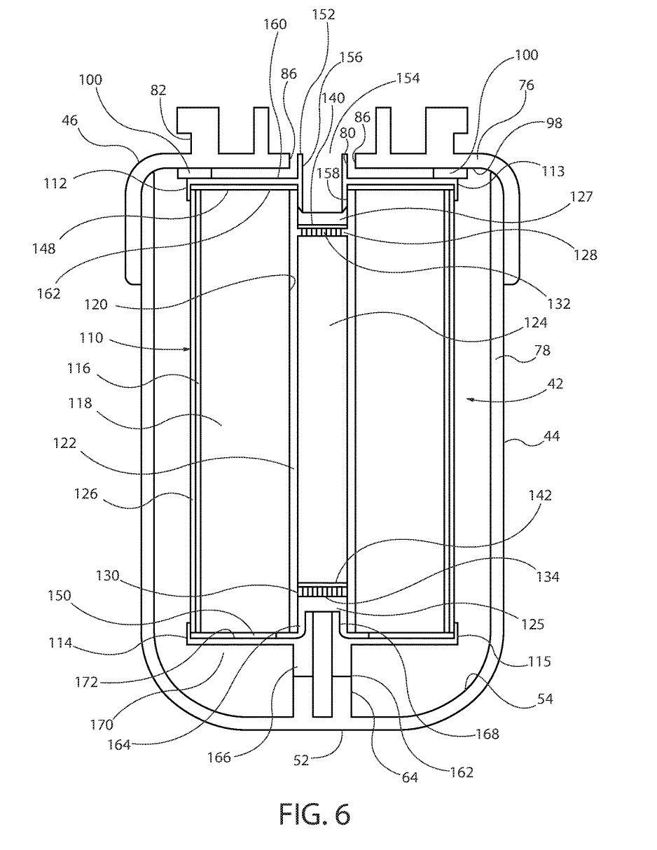

As illustrated in FIGS. 3A-3C, the shell 44 of the housing 40 can be generally cup-shaped, having an open upper end 48 (FIG. 6), a lower end 50 closed by a generally convex end wall 52 and a generally cylindrical sidewall 58 extending between the upper end 48 and the lower end 50. A centrally located ring-shape support member 64 projects up from the interior surface 54 of the end wall 52 of the shell 44. A plurality of radially extending ribs 66 can be provided on interior surfaces 54, 60 of the shell 44, which locate and support the filter assembly 42. The ribs 66 can each include foot and leg members 68 and 70, respectively. The foot members 68 are provided on the interior surface 54 of the end wall 52 and extend radially out toward the sidewall 58, and support the filter assembly 42 with the support member 72. The leg members 70 are provided on the interior surface 60 of the sidewall 58 and extend upwardly from the foot members 68, and center the filter assembly 42 within the shell 44 so that a water outlet 152 of the filter assembly 42 can aligned with a water outlet orifice 80 of the upper end cover 46.

Referring to FIG. 3A, a plurality of flat gripping recesses 72 or other gripping structure may be provided in an outer surface 62 of the shell's sidewall 58 to facilitate installation and removal of the water filter 22 on and from the filter mount 36 (FIGS. 1A and 1B) of the water supply system of the refrigerator 20. An arcuate-shaped groove 74 may be provided in an outer surface 56 of the shell's end wall 52 adjacent to a periphery 53 thereof, as best illustrated in FIG. 3C can be provided to facilitate the assembly of the filter housing 40.

Referring to FIGS. 2, 3A, 3B and 3C, the upper end cover 46 of the filter housing 40 can include a generally circular top wall 76 and a generally cylindrical sidewall 78 depending down from the periphery 77 of the top wall 76. The upper end cover 46 and shell 44 are sized so that when assembled and fastened to each other, the top wall 76 of the upper end cover 46 closes the open upper end 48 of the shell 44 and the sidewall 78 of the upper end cover 46 overlaps an upper portion of the sidewall 58 of the shell 44.

Referring to FIGS. 2, 3A, and 3B, the top wall 76 of the upper end cover 46 may include a centrally disposed circular opening 80 (FIG. 3B) extending therethrough and an annular mounting wall 82 extending up from an exterior surface 84 of the top wall 76 and spaced radially outward from and surrounding the opening 80. A tube structure 152, which is operative as a water outlet 154, may be received in the opening 80 of the upper cover 46. The circular opening 80 may include one or more cut-outs 86 that extend through the upper end cover 46 and are operative as water inlets. A pair of opposing lugs 92 extend radially outwardly from an upper portion of an outer side surface 88 of the mounting wall 82. Top surfaces 94 of the lugs 92 are flush with a top surface 90 of the mounting wall 82 and bottom surfaces 96 of the lugs 92 are spaced from the exterior surface 84 of the top wall 76. The lugs 92 are adapted to engage an opposing pair of L-shaped locking elements 37 (FIG. 1B) projecting from the filter mount 36 of the refrigerator when the filter is rotated about 90 degrees in a first direction from the position shown in FIG. 1B, which allow the water filter 22 to be removably attached to the filter mount 36. The water filter 22 can be removed from the filter mount 36 by rotating the filter about 90 degrees in an opposite second direction to disengage the lugs 92 from the L-shaped locking element 37.

When the water filter 22 is attached to the filter mount 36 as shown in FIG. 1B, the water inlet(s) 86 of the filter 22 enable unfiltered water provided by a water outlet (not shown) of the filter mount 36 to flow into the filter 22. The water outlet 154 of the filter 22 enables filtered water to flow into a water inlet (not shown) of the filter mount 36. An O-ring or other sealing element (not shown) can be provided on the mounting surface of the filter mount 36 to prevent water from leaking at the interface of the mounting wall top surface 90 of the water filter 22 and filter mount 36.

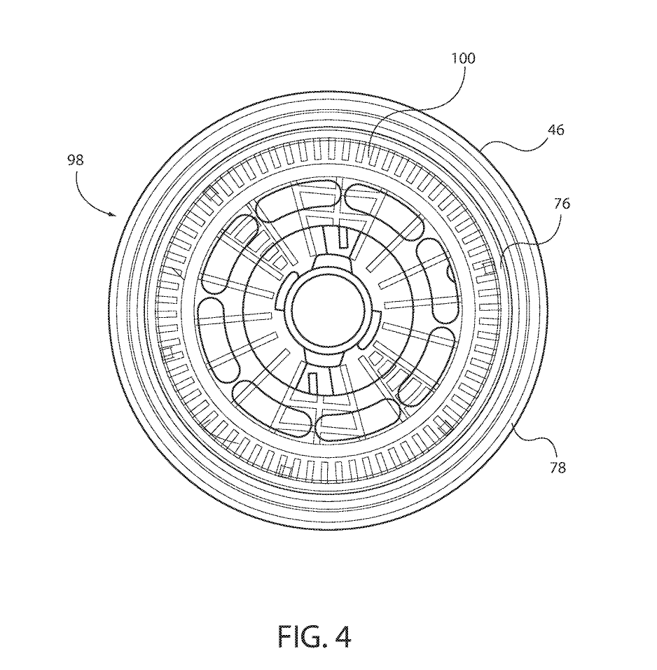

Referring to FIG. 4, the top wall 76 of the upper end cover 46 may further include a plurality of radially extending fins 100 on an interior surface 98 thereof, which surround the opening 80 and aid in directing the unfiltered water entering the water filter 22 through the water inlets 86 radially out toward the sidewall 78 of the cover 46 so that the water enters an interior space 102 (FIG. 3A) disposed between the sidewall 58 of the shell 44 and the filter assembly 42.

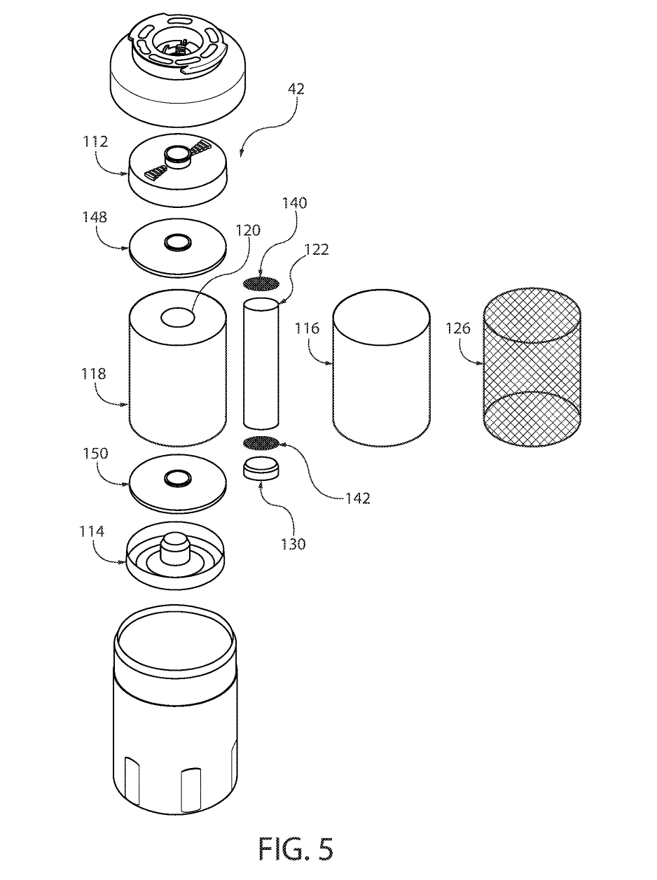

Referring to FIGS. 5 and 6, the filter assembly 42 may comprise a cylindrical filtering structure, which is retained between an upper end filter element cap 112 (upper filter cap 112), and a lower end filter element cap 114 (lower filter cap 114). The filtering structure 110 may comprise a coaxial arrangement of three filtering elements (wherein the filtering elements have or share a common axis) comprising first filtering element 116 wrapped about a generally cylindrical second filtering element 118, which may include a cylindrical elongated bore 120 extending therethrough. A tubular inner core member 122 can be disposed in the bore 120 of the second filtering element 118, and contains a third filtering element 124. A retaining element 126 may be wrapped about the first filtering element 116 to hold it against an outer surface 128 of the second filtering element 118.

The tubular inner core member 122 may include an open lower end 125 and an upper end 126 closed by a recessed perforated end wall 128. The open lower end 125 of the core member 122 may be closed by a perforated lid 130. The perforated end wall 128 and the perforated lid 130 may each have a plurality of openings 132, 134, extending therethrough that allow water to enter the core member 122 via the openings 134 of the lid 130, flow through the third filtering element 124 and exit the core member 122 through the openings 132 of the end wall 128. The exterior surface of the perforated end wall 128 and the interior surface of the perforated lid 130 may each be covered by a netting element 140, 142.

The filtering structure 110 may have circular-shaped first and second ends, which are received within and covered by the upper and lower filter caps 112, 114. The upper and lower filter caps 112, 114 may each have a relatively short cylindrical skirt 113, 115, which slightly overlaps the cylindrical outer surface of the filtering structure 110 to securely retain the filtering structure 110 therebetween. A first binder layer 148 can be provided, which adhesively bonds the upper filter cap 112 to the first end of the filtering structure 110 and a second binder layer 150 can be provided, which adhesively bonds the lower filter cap 114 to the second end of the filtering structure 110.

The upper filter cap 112 can include the earlier described tube structure 152, which is operative as the water outlet 154 of the filter assembly 42. The tube structure 152 can be centrally located within the upper filter cap 112. The tube structure 152 can include a first tubular member 156 and a second tubular member 158. The first tubular member 156 projects upwardly from an exterior surface 160 of the upper filter cap 112 and terminates in the water outlet orifice 80 of the upper end cover 46. The second tubular member 158 projects downwardly from an interior surface 162 of the upper filter cap 112 and may terminate inside the upper end 127 of the inner core member 122 above the recessed perforated end wall 128 thereof.

The lower filter cap 114 can include a centrally located tube structure 162, which is configured to allow a water exiting the second filtering element 118 to enter the third filtering element 124. The tube structure 162 can include a first tubular member 166 and a second tubular member 168. The first tubular member 166 projects downwardly from an exterior surface 170 of the lower filter cap 114 and may engage the ring-shape support 64 projecting up from the interior surface 54 of the end wall 52 of the shell 44. The second tubular member 168 has a tapered structure which projects upwardly from an interior surface 172 of the lower filter cap 114 and terminates inside the lower end 125 of the inner core member 122 just below the perforated lid 130. The tapered structure of the second tubular member 168 provides a space 164, which allows water exiting the second filtering element 118 to enter the third filtering element 124.

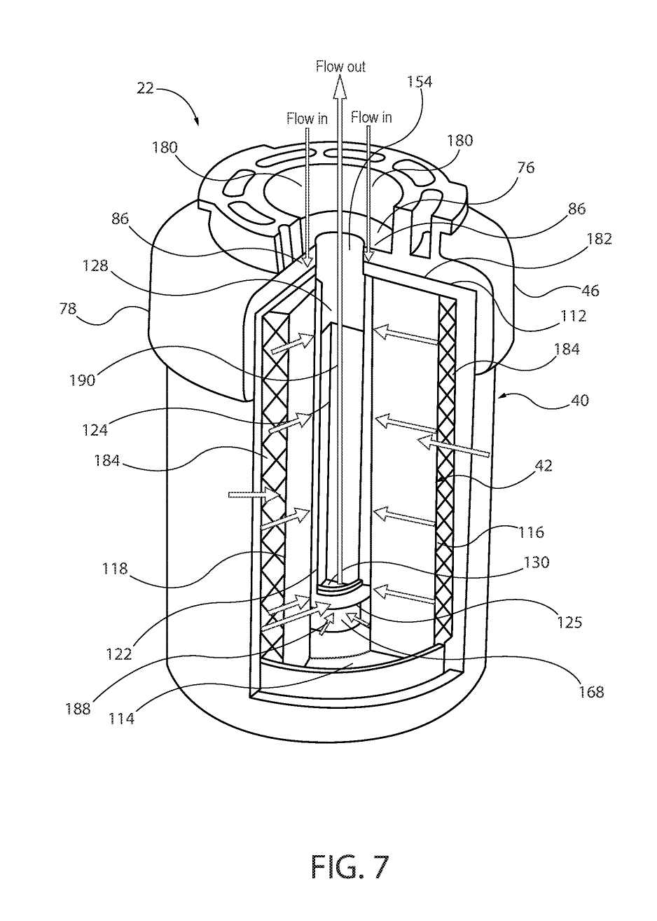

As illustrated in FIG. 7, unfiltered water (arrows 180) enters the water filter 22 through the one or more water inlets 86 in the top wall 76 of the upper end cover 46 of the filter housing 40. The unfiltered water 180 flows radially out (arrows 182) toward the sidewall 78 of the cover 46 and enters the interior space (arrows 184) surrounding the filter assembly 42. The unfiltered water is filtered as it flows radially inwardly (arrows 186) through the first filtering element 116, which removes and/or reduces larger particulate matter and sediment in the water, and then through the second filtering element 118, which through a combination of mechanical filtration and adsorption removes and/or reduces particulate matter and volatile organic contaminants in the water. The water filtered by the first and second filtering elements 116, 118, flows down the outer surface of the inner core member 122 and enters the open lower end 125 thereof through the space 164 (FIG. 6) provided between the tapered second tubular member 168 of the lower filter cap 114 and the lower end 125 of the inner core member 122 (arrows 188). The water then enters the inner core member 122 through the perforated lid 130 and flows up through the third filtering element 124 (arrow 190), which removes and/or reduces fluoride and/or arsenic in the water. The filtered water 190 exiting the third filtering element 124 passes up through the perforated end wall 128 and out the water outlet 154 of the upper filter cap 112 where it is discharged from the water filter 22.

The first filtering element 116 may comprise a non-woven fabric, or any other suitable material which is capable of removing and/or reducing larger particulate matter, such as sand, in the water. The non-woven fabric can be made from any suitable food-grade plastic material including without limitation polypropylene.

The second filtering element 118 may comprise a conventional carbon block made from a mass of compressed or extruded activated carbon particles, which are bonded together to form a dense block. The carbon block operates to remove and/or reduce a high percentage of particulate matter and volatile organic contaminants in the water through a combination of mechanical filtration and adsorption. The second filtering element 118 may also comprise any other suitable food-grade filtering element, which is capable of removing and/reducing, a high percentage of particulate matter and volatile organic contaminants in the water.

The third filtering element 124 contained in the inner core member 122 may comprise a plurality of highly porous (activated) alumina (Al₂O₃, aluminum oxide) pellets. In some embodiments, the alumina pellets may each be about 80 microns in diameter. The activated alumina third filtering element 124 is operative for removing and/or reducing fluoride and/or arsenic in the water. The activated alumna third filtering element 124 typically reduces and/or removes between 70 percent and 99 percent of the fluoride and/or arsenic in the water. It should be understood that the third filtering element 124 may also comprise any other suitable food-grade filtering element, which is capable of removing and/or reducing a high percentage of fluoride and/or arsenic in the water.

The first, second, and third filtering elements 116, 118, and 124 described above, enable the water filter 22 to meet NSF/ANSI standard 42 for water treatment.

The netting elements 140, 142 prevents the activated alumina pellets (the third filtering element 124) from flowing out of the inner core member 122 through the perforated end wall 128 and/or lid 130 during shipping and handling. Further, the netting element 140 also prevents the activated alumina pellets from flowing out of the inner core member 122 through the perforated end wall 128 with the filtered water during the operation of the water filter 22.

The upper and lower filters caps 112, 114, the inner core member 122, the perforated end wall 128, and perforated lid 130 can each be made from any suitable food-grade plastic material including without limitation polypropylene.

The netting elements 140, 142 can each be made from any suitable food-grade plastic material including without limitation nylon.

The retaining element 126 may comprise a netting material. The netting material can be made from any suitable food-grade plastic material including without limitation polyethylene.

The first and second binder layers 148, 150 can be made from any suitable food-grade adhesive.

The upper end cover 46 and shell 44 of the filter housing 40 can each be made from any suitable food-grade transparent or opaque plastic material including without limitation polypropylene.

Although the water filter has been described in terms of illustrative embodiments, it is not limited thereto. Rather, the appended claims should be construed broadly to comprise other variants and embodiments of the water filter, which may be made by those skilled in the art without departing from the scope and range of equivalents of the same.

What is claimed is:

1. A replaceable filter for filtering a water supply of a refrigerator, the filter comprising:
a filter assembly comprising a first filtering element for at least one of removing and reducing at least one of fluoride and arsenic in the water; and
a housing containing the filter assembly, the housing including a first end adapted to removably attach the filter to a filter mount of the refrigerator where the filter communicates with the water supply of the refrigerator.

2. The filter of claim 1, wherein the first filtering element comprises activated alumina.

3. The filter of claim 1, wherein the filter assembly further comprises a second filtering element for at least one of removing and reducing particulate matter in the water.

4. The filter of claim 3, wherein the second filtering element comprises fabric.

5. The filter of claim 3, wherein the filter assembly further comprises a third filtering element for at least one of removing and reducing particulate and organic contaminants in the water.

6. The filter of claim 5, wherein the third filtering element comprises a carbon block.

7. The filter of claim 1, wherein the filter assembly further comprises a second filtering element for at least one of removing and reducing particulate and organic contaminants in the water.

8. The filter of claim 7, wherein the second filtering element comprises a carbon block.

9. A replaceable filter for filtering a water supply of a refrigerator, the filter comprising:
a filter assembly comprising first and second filtering elements, the first filtering element for at least one of removing and reducing particulate and organic contaminants in the water and the second filtering element for at least one of removing and reducing at least one of fluoride and arsenic in the water; and
a housing containing the filter assembly, the housing including a first end adapted to removably attach the filter to a filter mount of the refrigerator where the filter communicates with the water supply of the refrigerator.

10. The filter of claim 9, wherein the first filtering element comprises a carbon block.

11. The filter of claim 10, wherein the second filtering element comprises activated alumina.

12. The filter of claim 9, wherein the filter assembly includes a tubular core member which contains the second filtering element.

13. The filter of claim 12, wherein the first filtering element is disposed about the tubular core member.

14. The filter of claim 13, wherein the filter assembly further comprises a filter cap including a tubular member extending into an inlet end of the tubular core member, the tubular member being tapered to provide a space between the inlet end of the tubular core member and the tubular member, thereby allowing water filtered by the first filtering element to enter the tubular core member and be filtered by the second filtering element.

15. The filter of claim 9, wherein the filter assembly further comprises a third filtering element for at least one of removing and reducing particulate matter in the water.

16. The filter of claim 15, wherein the third filtering element comprises fabric.

17. A replaceable filter for filtering a water supply of a refrigerator, the filter comprising:
a filter assembly comprising a filter structure having first, second, and third filtering elements sharing a common axis, the first filtering element for at least one of removing and reducing particulate contaminants in the water, the second filtering element for at least one of removing and reducing particulate and organic contaminants in the water and the third filtering element for at least one of removing and reducing at least one of fluoride and arsenic in the water; and
a housing containing the filter assembly, the housing including a first end adapted to removably attach the filter to a filter mount of the refrigerator where the filter communicates with the water supply of the refrigerator.

18. The filter of claim 17, wherein the first filtering element comprises fabric, the second filtering element comprises a carbon block, and the third filtering element comprises activated alumina.

19. The filter of claim 18, wherein the first filtering element is wrapped about the second filtering element.

20. The filter of claim 19, wherein the second filtering element includes a bore, and wherein the filter assembly further comprises a tubular core member disposed in the bore, the tubular core member containing the third filtering element.

21. The filter of claim 20, wherein the filter assembly further comprises a filter cap including a tubular member extending into an inlet end of the tubular core member, the tubular member being tapered to provide a space between the inlet end of the tubular core member and the tubular member, thereby allowing water filtered by the first and second filtering elements to enter the tubular core member and be filtered by the third filtering element.

22. The filter of claim 21, wherein the filter cap comprises a first filter cap and the filter assembly further comprises a second filter cap, the filter structure being retained between the first and second filter caps, the second filter cap comprising a tubular member extending into an outlet end of the tubular core member and operative as a water outlet.

23. The filter of claim 17, wherein the second filtering element includes a bore, and wherein the filter assembly further comprises a tubular core member disposed in the bore, the tubular core member containing the third filtering element.

24. The filter of claim 23, wherein the filter assembly further comprises a filter cap including a tubular member extending into an inlet end of the tubular core member, the tubular member being tapered to provide a space between the inlet end of the tubular core member and the tubular member, thereby allowing water filtered by the first and second filtering elements to enter the tubular core member and be filtered by the third filtering element.

25. The filter of claim 24, wherein the filter cap comprises a first filter cap and the filter assembly further comprises a second filter cap, the filter structure being retained between the first and second filter caps, the second filter cap comprising a tubular member extending into an outlet end of the tubular core member and operative as a water outlet.
